(19) United States
(12) Patent Application Publication
(10) Pub. No.: US 2006/0243363 A1
(43) Pub. Date: Nov. 2, 2006

(54) Glass microbubble-containing syntactic foams, explosives, and method of making

(75) Inventors: Robert W. Hunter, Burnsville, MN (US); Harry J. Marshall, Hudson, WI (US); Madeline P. Shinbach, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/412,247

(22) Filed: Apr. 26, 2006

Related U.S. Application Data
(60) Provisional application No. 60/676,404, filed on Apr. 29, 2005.

(51) Int. Cl. D03D 23/00; C08J 9/00

(52) U.S. Cl. 149/109.2; 521/122

(57) ABSTRACT

A syntactic foam and water-based explosive comprising glass microbubbles formed by heating feed having a size distribution with a span of less than 0.9 that are dispersed in a polymeric matrix or emulsion explosive. A method for making glass microbubbles, syntactic foam and water-based explosives is described.

### CROSS REFERENCE TO RELATED APPLICATION

This application claims the benefit of U.S. Provisional Patent Application No. 60/676,404, filed Apr. 29, 2005, the contents of which are hereby incorporated by reference.

### BACKGROUND

Glass syntactic foams are low-density composites made from hollow glass microspheres, also known as glass bubbles or glass microbubbles, dispersed in a continuous matrix of polymeric, typically high strength, resin. These syntactic foams are differentiated from blown, or gassed, closed cell foams in that the syntactic foams are more robust and are able to withstand processing conditions and environments (pressures and temperatures) which would destroy blown closed cell foams. Glass syntactic foams have found application in a variety of severe environments. Examples include deep water buoyancy modules, cementitious slurries and composites (i.e., well casing cements), composite particles useful in oil well drilling and fracturing (i.e., dual density gradient particles and low density proppants).

There exists a continuing desire for syntactic foam composites with improved properties, e.g., higher strength to density ratios.

Water-based explosives are commonly classified into two types: emulsions and water gels or slurries. The emulsion type explosive consists of a dispersed phase of an aqueous oxidizer solution and continuous phase of an organic fuel. Water-gel and slurry types of water-based explosives consist of an organic fuel as the dispersed phase and oxidizer-saturated water as the continuous phase. Both types of water-based explosives require a sensitizer to enable detonation to occur, usually in the form of small bubbles. These bubbles may be hollow microspheres or gas bubbles. It is generally known in the explosives art that smaller bubbles and uniform distribution of these bubbles throughout the explosive provides good performance.

It is known to add a sensitizer in the form of small hollow microspheres or bubbles to water-based explosive. Examples of such microspheres include those made of glass, water glass, organic polymer, or perlite. These hollow microspheres eliminate the problem of bubble coalescence.

Hollow glass beads having a median diameter of less than about 500 micrometers, also commonly known as “hollow glass microspheres” or “glass microbubbles”, are widely used in industry, for example, as additives to polymeric compounds where they may serve as modifiers, enhancers, rigidifiers, and/or fillers. Generally, it is desirable that the glass microbubbles be strong to avoid being crushed or broken during further processing of the polymeric compound, such as by high pressure spraying, kneading, extrusion or injection molding.

Glass microbubbles are typically made by heating milled frit, commonly referred to as “feed”, that contains a blowing agent such as, for example, sulfur or a compound of oxygen and sulfur. The resultant product (i.e., “raw product”) obtained from the heating step typically contains a mixture of glass microbubbles (including broken glass microbubbles) and solid glass beads, the solid glass beads generally resulting from milled frit particles that failed to form glass microbubbles for whatever reason.

The milled frit is typically obtained as a relatively broad distribution of particle sizes. During heating, the larger particles tend to form glass microbubbles that are more fragile than the mean, while the smaller particles tend to increase the density of the hollow glass bead distribution. In the case that larger glass microbubbles become broken, the average density of the glass bead distribution containing the broken bead portions also generally increases.

### SUMMARY

In one aspect, it has been discovered that hollow glass microspheres made from narrowly distributed glass feed sizes, as described in copending U.S. patent application Ser. No. 11/004385, filed Dec. 3, 2004, enable the manufacture of articles with improved properties, including glass syntactic foam composites with higher strength to density ratios. Such composites have application in many industrial markets and applications.

Higher strength to density ratio products can also be defined as specific strength. Specific strength is attained by dividing the rated isostatic pressure resistance (see Strength Test) of a given sample of hollow glass microspheres, or of a composite made from those microspheres, by the average true density of the sample.

In one aspect, the invention provides a method for forming glass microbubbles comprising (1) heating feed under conditions sufficient to convert at least a portion of the feed into raw product comprising glass microbubbles, wherein the feed has a size distribution with a span of less than 0.9 and (2) incorporating the raw product into a resin to form a syntactic foam composite.

In another aspect, the present invention provides a syntactic foam composite comprising a polymeric resin and glass microbubbles wherein a plurality of the microbubbles has a size distribution with a span of less than 0.80.

The present invention can be used to make feasible production of syntactic foam composites for a selected application via production techniques that might previously have been unsuitable because the conditions were too deleterious to the microbubble components of the composite. The present invention can be used to make improved syntactic foam composites that provide improved physical properties.

In another aspect, the invention provides water-based explosives comprising aqueous oxidizer solution, fuel, and raw product as described herein.

“Sensitizer” means hollow glass microbubbles or raw product which provide density discontinuities within the explosive.

In another aspect, the invention provides a water-based explosive precursor composition. The precursor composition comprises aqueous oxidizer solution, fuel, and microbubbles or raw product.

As used herein, “water-based explosive” includes explosives that are in the form of a liquid, gel, slurry, suspension, emulsion, colloid, and the like, wherein the explosive contains an oxidizer dissolved in water. The water may be the continuous phase, e.g., water gels and slurries, or discontinuous phase in the case of emulsions.

Some of the advantages of the explosives of the invention are expected to be improved explosive performance.

### DETAILED DESCRIPTION OF ILLUSTRATIVE EMBODIMENTS

Production of Glass Bubbles

For any given heating process, it is generally the case that the density of the resultant hollow glass bead distribution correlates with the throughput rate at which the feed is converted into glass microbubbles. Thus, in order to produce low density glass microbubbles it is generally necessary to use relatively lower throughput rates using a given process and apparatus. By using feed having a narrower particle size distribution than those currently used by the glass microbubble industry, the present invention generally achieves a lower density distribution of glass microbubbles or raw product in a syntactic foam, having an average crush strength comparable to higher density distributions of glass microbubbles or raw product.

Frit may be prepared, for example, by crushing and/or milling a suitable glassy material, typically a relatively low melting silicate glass containing a suitable amount of blowing agent. Silicate glass compositions suitable for forming frit are described, for example, in U.S. Pat. No. 2,978,340 (Veatch et al.); U.S. Pat. No. 3,030,215 (Veatch et al.); U.S. Pat. No. 3,129,086 (Veatch et al.); and U.S. Pat. No. 3,230,064 (Veatch et al.); U.S. Pat. No. 3,365,315 (Beck et al.); and U.S. Pat. No. 4,391,646 (Howell), the disclosures of which are incorporated herein by reference in their entirety.

Although the frit and/or the feed may have any composition that is capable of forming a glass, typically, on a total weight basis, the frit comprises from 50 to 90 percent of SiO₂, from 2 to 20 percent of alkali metal oxide, from 1 to 30 percent of B₂O₃, from 0.005 to 0.5 percent of sulfur (e.g., as elemental sulfur, sulfate or sulfite), from 0 to 25 percent divalent metal oxides (e.g., CaO, MgO, BaO, SrO, ZnO, or PbO), from 0 to 10 percent of tetravalent metal oxides other than SiO₂ (e.g., TiO₂, MnO₂, or ZrO₂), from 0 to 20 percent of trivalent metal oxides (e.g., Al₂O₃, Fe₂O₃, or Sb₂O₃), from 0 to 10 percent of oxides of pentavalent atoms (e.g., P₂O₅ or V₂O₅), and from 0 to 5 percent fluorine (as fluoride) which may act as a fluxing agent to facilitate melting of the glass composition. Additional ingredients are useful in frit compositions and can be included in the frit, for example, to contribute particular properties or characteristics (e.g., hardness or color) to the resultant glass microbubbles.

In the above-mentioned frit compositions, sulfur (presumably combined with oxygen) serves as a blowing agent that, upon heating, causes expansion of molten frit particles to form glass microbubbles. By controlling the amount of sulfur in the feed, the amount and length of heating to which the feed is exposed, the median particle size, and the rate at which particles are fed through a flame the amount of expansion of the feed particles can typically be controlled to provide glass microbubbles of a selected density. Although the frit generally includes sulfur within a range of about 0.005 to 0.7 weight percent, more typically, the sulfur content of the frit is in a range of from 0.01 to 0.64 percent by weight, or even in a range of from 0.05 to 0.5 percent by weight.

The frit is typically milled, and optionally classified, to produce feed of suitable particle size for forming glass microbubbles of the desired size. Methods that are suitable for milling the frit include, for example, milling using a bead or ball mill, attritor mill, roll mill, disc mill, jet mill, or combination thereof. For example, to prepare feed of suitable particle size for forming glass microbubbles, the frit may be coarsely milled (e.g., crushed) using a disc mill, and subsequently finely milled using a jet mill.

Jet mills are generally of three types: spiral jet mills, fluidized-bed jet mills, and opposed jet mills, although other types may also be used.

Spiral jet mills include, for example, those available under the trade designations “MICRONIZER JET MILL” from Sturtevant, Inc., Hanover, Mass.; “MICRON-MASTER JET PULVERIZER” from The Jet Pulverizer Co., Moorestown, N.J.; and “MICRO-JET” from Fluid Energy Processing and Equipment Co., Plumsteadville, Pa. In a spiral jet mill a flat cylindrical grinding chamber is surrounded by a nozzle ring. The material to be ground is introduced as particles inside the nozzle ring by an injector. The jets of compressed fluid expand through the nozzles and accelerate the particles, causing size reduction by mutual impact.

Fluidized-bed jet mills are available, for example, under the trade designations “CGS FLUIDIZED BED JET MILL” from Netzsch Inc., Exton, Pa.; and “ROTO-JET” from Fluid Energy Processing and Equipment Co. The lower section of this type of machines is the grinding zone. A ring of grinding nozzles within the grinding zone is focused toward a central point, and the grinding fluid accelerates particles of the material being milled. Size reduction takes place within the fluidized bed of material, and this technique can greatly improve energy efficiency.

Opposed jet mills are similar to fluidized-bed jet mills, except at least two opposed nozzles accelerate particles, causing them to collide at a central point. Opposed jet mills may be commercially obtained, for example, from CCE Technologies, Cottage Grove, Minn.

There are many ways to describe the width of a particle size distribution. In one method, the width of a particle size distribution can be expressed by the following formula:

$$\frac{90 P - 10 P}{50 P} = GQ = span$$

wherein 90 P is the size for which 90 percent of the particles in the distribution are smaller (referred to as the 90th percentile size); 10 P is the size for which only 10 percent of the particles in the distribution are smaller (referred to as the 10th percentile size); 50 P is the size for which 50 percent of the particles in the distribution are smaller (referred to as the 50th percentile size); and GQ stands for the gradation quotient. The gradation quotient is also commonly known in the art by the term “span”.

Another common method, particularly useful for Gaussian particle size distributions, uses the median and standard deviation of the particle sizes to describe the distribution.

According to the present invention, the milled frit is classified to yield a distribution of having a span of less than 0.9, which is then used as feed for forming glass microbubbles. For example, the feed may have a span of less than 0.85, 0.80, or even less than 0.75; the span may also be at least 0.7. In order to form glass microbubbles on heating, the feed typically has a median particle size of from at least about 3 to about 100 micrometers, more typically from at least about 3 to about 50 micrometers, and more typically from at least about 5 to about 25 micrometers.

By utilizing narrow feed distributions, the present invention provides an additional degree of control that may be used in the production of glass microbubbles as compared to current methods for forming glass microbubbles known in the art. Typically, the main process variables in the formation of glass microbubbles are the equipment, sulfur content, and the feed rate, and median feed size. Controlling the feed size distribution according to the present invention advantageously provides an additional process variable that may be varied to achieve a desired result.

Classification is performed such that at least one fraction, typically the coarsest classified portion, of the feed has a span of less than 0.9. This fraction is therefore isolated and used as the feed for the manufacture of the glass microbubbles. Remaining finer and/or coarser fraction(s) may be, for example, used to make glass microbubbles having physical properties comparable to existing glass microbubbles or reprocessed into frit.

Typically, as obtained from the above-mentioned mills each technique produces feed having a distribution of particle sizes. Typically, feed obtained from milling will not have a span of less than 0.9, and in such cases additional classification according to the present invention is desirable.

Suitable apparatus for classifying the feed include, for example, vibrating screens (including sieves), air classifiers, and wet classifiers. Other methods of classifying the feed may also be used.

Suitable screens include, for example, sieves having a designation of from about 35 mesh through at least about 400 mesh according to ASTM Designation: E11-04 entitled “Standard Specification for Wire Cloth and Sieves for Testing Purposes”. Such sieves may be obtained from commercial suppliers such as, for example, Newark Wire Cloth Company, Newark, N.J.

Suitable air classifiers include, for example, gravitational classifiers, inertial classifiers, and centrifugal classifiers. Air classifiers are readily available from commercial sources, for example, as available from Hosokawa Micron Powder Systems under the trade designations “MICRON SEPARATOR”, “ALPINE MODEL 100 MZR”, “ALPINE TURBOPLEX ATP”, “ALPINE STRATOPLEX ASP”, or “ALPINE VENTOPLEX”; or from Sepor, Inc., Wilmington, Calif. under the trade designation “GAYCO CENTRIFUGAL SEPARATOR”.

Once the feed has the desired span, it is fed into a heat source (e.g., a gas/air flame, approximately stoichiometric) and then cooled. Upon exposure to the heat source the feed typically softens and the blowing agent causes at least a portion of the softened feed to expand and, after cooling, form a raw product that comprises glass microbubbles, optionally in combination with broken microbubble glass fragments and/or solid glass beads that did not expand during heating. Generally, it is possible to adjust process conditions such that at least a majority by weight of the raw product comprises glass microbubbles. More typically, at least 60, 70, 80, or even 90 percent by weight of the raw product comprises glass microbubbles. If desired, at least a portion of the glass microbubbles may be isolated from the raw product, for example, by using flotation techniques as described in U.S. Pat. No. 4,391,646 (Howell).

Glass microbubbles may be prepared on apparatus such as those described, for example, in U.S. Pat. No. 3,230,064 (Veatch et al.) or U.S. Pat. No. 3,129,086 (Veatch et al.). Further details concerning heating conditions may be found for example in U.S. Pat. No. 3,365,315 (Beck et al.) and U.S. Pat. No. 4,767,726 (Marshall), the disclosures of which are incorporated herein by reference in their entirety.

According to the present invention, the raw product typically has a median particle size in a range of from 3 to 250 micrometers, more typically 5 to 150 micrometers, more typically 5 to 110 micrometers. In some embodiments, the raw product may have a median particle size of at least 70 micrometers. The raw product has a span of less than 0.80, or in some embodiments, less than 0.75, 0.70, 0.65, or even less than 0.60.

In one embodiment, the glass microbubbles may have a weight ratio of alkaline earth metal oxide to alkali metal oxide weight ratio in a range of 1.2:1 to 3.0:1, and wherein at least 90 percent by weight of the combined oxides comprises 70 to 80 percent SiO₂, 8 to 15 percent CaO, 3 to 8 percent Na₂O, and 2 to 10 percent B₂O₃.

Production of Syntactic Foam

A syntactic foam composite of the invention is prepared by incorporating the glass microbubbles or raw product described above into a polymeric resin matrix.

Suitable resins include thermoset and thermoplastic resins and may be readily selected by those skilled in the art, usually dependent in at least part on the desired application. Illustrative examples include thermosets such as epoxy, polyester, polyurethane, polyurea, silicone, polysulfide, and phenolic resins and thermoplastics such as polyolefins (e.g., polypropylene, polyethylene, fluorinated polyolefins (e.g., pTFE, FEP, PFA, pCTFE, pECTFE, and PETFE), polyamide, polyamide-imide, polyether-imde, polyetherketone resins, and blends of two or more such resins. The resin may be elastomeric or not as desired. If desired, other additives might be incorporated in the foam composite as desired, e.g., preservatives, mixing agents, colorants, dispersents, floating or anti-setting agents, wetting agents, air separation promoters, water scavengers, etc.

Suitable techniques and processes for incorporating selected raw product or microbubbles as described above into the resin to form the desired syntactic foams may be readily selected by those skilled in the art. One of the advantages of the present invention is that the increased strength to density ratio of the glass microbubbles may permit the use of more rigorous foam composite formation or manipulation processes, thus enabling other goals to be achieved.

Some illustrative examples of foam manufacturing processes that may be used in the present invention include batch processing, cast curing, meter mixing, reaction injection molding, continuous solids dispersion mixing, centrifugal planetary mixing which are known to be used for thermoset formulations, and compounding extrusion, and injection molding which are known to be used for thermoplastic formulations.

Some illustrative embodiments of the invention would be prepared as follows.

Glass Syntactic Polyurethane (“GSPU”) pipe coating insulation is prepared by first mixing suitable microbubbles or raw product, usually of at least 2000 PSI isostatic pressure collapse resistance, with liquid polyol resins, chain extenders, catalysts, driers, etc., and degassed. The volume fraction of microbubbles or raw product in these systems is often approx. 0.5. This premix is mixed with isocyanate crosslinkers, immediately pumped into a mold cavity surrounding a length of pipe, or otherwise dispensed onto the pipe, to make a thermally insulating polyurethane pipe coating. Higher specific strength microbubbles or raw product allows for either a lower density, and therefore lower thermal conductivity, pipe coating composite at a given mechanical strength, which can be thought of in terms of depth rating, or ability to be handled in harsh conditions during the pipe laying process, etc., or a higher mechanical strength (depth rating, etc.) at a given density.

Glass Syntactic Polypropylene (“GSPP”) thermoplastic thermal insulation pipe coatings comprise microbubbles or raw product dispersed in a thermoplastic resin, usually polypropylene, and coated onto the pipe in a side extrusion or cross-head extrusion process. These coatings benefit from the increased specific strength microbubbles or raw product in two ways. First, this thermoplastic coating is mixed in a compounding extruder at relatively high volume fractions, again around 0.5, and applied from the extruder or a melt pump at moderate to high pressures, so the microbubbles or raw product have to pass that first potential breakage regime in the extruder, as well as the microbubbles or raw product now coated onto the pipe have to survive the harsh conditions being handled in the field and in the pressures exerted onto the coating in deep water.

Explosives

Liquid or water-based explosives comprise an aqueous oxidizer solution and fuel in the form of an emulsion, slurry, or gel. Examples of oxidizers that are useful in water-based explosives of the invention include but are not limited to nitrate, chlorate, or perchlorate salts of ammonium, sodium or potassium, hydrazines, organic amides, such as monomethyl amine nitrate, and combinations thereof.

Examples of fuels that are useful in water-based explosives include any fuel capable of being oxidized in a water-based explosive as defined in this application. Specific examples include, but are not limited to, fuel oil, diesel fuel, gasoline, kerosene, jet fuel, alcohols, waxes, as well as solid organic and metal particles, e.g., aluminum, and the like.

The water-based explosives of the invention include microbubbles or raw product made from a feed having a span of less than 0.9. For example, the feed may have a span of less than 0.85, 0.80, or even less than 0.75; the span may also be at least 0.7. In order to form glass microbubbles on heating, the feed typically has a median particle size of from at least about 3 to about 100 micrometers, more typically from at least about 3 to about 50 micrometers, and more typically from at least about 5 to about 25 micrometers.

The resulting raw product useful for water-based explosive applications has a median particle diameter in the range of from at least about 3 to 150 micrometers, more typically from at least about 5 to 100 micrometers and more typically from at least about 10 to 80 micrometers.

The microbubbles may be surface treated if desired. A variety of methods are available for modifying the surface of microbubbles including, e.g., adding a surface modifying agent to the microbubbles (e.g., in the form of a powder or a colloidal dispersion) and allowing the surface modifying agent to react with the microbubbles. Other useful surface modification processes are described in, e.g., U.S. Patent No. 2,801,185 (Iler) and U.S. Pat. No. 4,522,958 (Das et al.).

Various methods may be employed to combine the microbubbles or raw product and the aqueous oxidizer solution-fuel mixture. In one method, a water in oil emulsion is prepared. Microbubbles or raw product are then added and uniformly mixed into the emulsion.

Raw product may be present in the aqueous oxidizer solution-fuel mixture in varying amounts including, e.g., from about 0.1% by dry weight to about 20% by dry weight, from about 0.5% by dry weight to about 10% by dry weight, and from about 0.5% by dry weight to about 5% by dry weight based on the total weight of the composition. The raw product is preferably dispersed throughout the aqueous oxidizer solution-fuel mixture, more preferably dispersed uniformly throughout the aqueous oxidizer solution-fuel mixture.

Thus a specific use of the improved specific strength microbubble or raw product as described herein is in the area of emulsion explosive sensitization. Use of raw product as described herein can improve the dead-pressing resistance of the emulsion explosive. Dead-pressing is the resistance of the microbubbles to collapse due to the shock of explosion. Use of the higher specific strength microbubble in accordance with this invention will allow for a packaged emulsion explosive with improved dead-pressing resistance and increased explosive output per unit volume. This is due to the fact that there will be more explosive and less inert glass per unit volume in the package, while maintaining the critical sensitized density of the emulsion.

Illustrative Uses

Glass microbubbles prepared according to the present invention may be included in polymeric materials and may optionally be mixed with solid glass beads. Examples of suitable polymeric materials include thermoset, thermoplastic, and elastomeric polymeric materials.

The present invention may be used to advantage in a variety of syntactic foam applications. Some illustrative examples include: in the transportation market, e.g., body fillers, frame stiffening foams, underbody and seam sealing coatings, sheet molding compound/bulk molding compounds, reaction injection molded parts, compounded and injection molded parts; in the construction market, e.g., sprayable paints and architectural coatings, composite wood substitutes; in the aerospace market, e.g., void fillers, high performance, ultra-low density starved foams and other composites applications where higher strength to density performance is required; and in the wire and cable market, e.g., low dielectric constant extruded wire jackets and cable filling compounds.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

In the following examples:

“borax” refers to anhydrous borax; Na₂O:2B₂O₃, 90 percent smaller than 590 micrometers, obtained from US Borax, Boron, Calif.;

“CaCO₃” refers to calcium carbonate, 97 percent smaller than 44 micrometers, obtained from Imerys, Sylacauga, Ala.;

“Li₂CO₃” refers to lithium carbonate; finer than 420 micrometers obtained from Lithium Corp. of America, Gastonia, N.C;

“SiO₂” refers to silica flour, obtained from US Silica, Berkeley Springs, W.V.;

“Na₂CO₃” refers to soda ash, obtained from FMC Corp., Greenvine, Wyo.;

“Na₂SO₄” refers to sodium sulfate, 60 percent smaller than 74 micrometers, obtained from Searles Valley Mineral, Trona, Calif.; and

“Na₄P₂O₇” refers to tetrasodium pyrophosphate, 90 percent smaller than 840 micrometers, obtained from Astaris, St. Louis, Mo.

Test Methods

Average Particle Density Determination

A fully automated gas displacement pycnometer obtained under the trade designation “ACCUPYC 1330 PYCNOMETER” from Micromeritics, Norcross, Ga., was used to determine the density of the composite material and glass residual according to ASTM D-2840-69, “Average True Particle Density of Hollow Microspheres”.

Particle Size Determination

Particle size distribution was determined using a particle size analyzer available under the trade designation “COULTER COUNTER LS-130” from Beckman Coulter, Fullerton, Calif.

Strength Test

The strength of the glass microbubbles is measured using ASTM D3102-72; “Hydrostatic Collapse Strength of Hollow Glass Microspheres” with the exception that the sample size of glass microbubbles is 10 mL, the glass microbubbles are dispersed in glycerol (20.6 g) and data reduction was automated using computer software. The value reported is the hydrostatic pressure at which 10 percent by volume of the raw product collapses.

Preparation Of Frit

### Frit GFC-1

Frit was prepared by combining the following components: SiO₂ (600.0 g), Na₂O. 2B₂O₃ (130.8 g), CaCO₃ (180.0 g), Na₂CO₃ (18.7 g), Na₂SO₄ (20.0 g) Na₄P₂O₇ (6.5 g) and Li₂CO₃ (10.7 g). Mixing was carried out by tumbling for 3 minutes in an 8.7-liter jar mill with 6000 grams of alumina grinding cylinders (both from VWR Scientific, West Chester, Pa.). The batches were melted for 3 hours in fused silica refractory crucible (N size; available from DFC Ceramics, Canon City, Colo.) at a temperature of about 1290° C. (2350° F.) in a quick recovery electrically heated furnace (from Harper Electric, Terryville, Conn.). The resulting molten glass was quenched in water and dried resulting in Frit GFC-1.

### Frits GFC-2 through GFC-10 and GF-1 through GF-4

Frits GFC-2 to GFC-10 and GF-1 through GF-4 were prepared according to the procedure described for frit GFC-1, except that the glass composition was varied as reported in Table 1 (below).

TABLE 1

| | Amount of Component, grams | | | | | | |
|---|---|---|---|---|---|---|---|
| Frit | SiO₂ | Na₂O.2B₂O₃ | Na₂CO₃ | CaCO₃ | Na₂SO₄ | Na₄P₂O₇ | Li₂CO₃ |
| GFC-2 | 600.0 | 130.8 | 18.7 | 180.0 | 20.0 | 6.5 | 10.7 |
| GFC-3 | 600.0 | 130.8 | 18.7 | 180.0 | 20.0 | 6.5 | 10.7 |
| GFC-4 | 600.0 | 123.9 | 58.5 | 172.9 | 5.0 | 0 | 0 |
| GFC-5 | 600.0 | 123.9 | 58.5 | 172.9 | 5.0 | 0 | 0 |
| GFC-6 | 600.0 | 123.9 | 58.5 | 172.9 | 5.0 | 0 | 0 |
| GFC-7 | 600.0 | 130.8 | 18.7 | 180.0 | 20.0 | 6.5 | 10.7 |
| GFC-8 | 600.0 | 130.8 | 18.7 | 180.0 | 20.0 | 6.5 | 10.7 |
| GFC-9 | 600.0 | 123.9 | 58.5 | 172.9 | 5.0 | 0 | 0 |
| GFC-10 | 600.0 | 123.9 | 58.5 | 172.9 | 5.0 | 0 | 0 |
| GF-1 | 600.0 | 130.8 | 18.7 | 180.0 | 20.0 | 6.5 | 10.7 |
| GF-2 | 600.0 | 123.9 | 58.5 | 172.9 | 5.0 | 0 | 0 |
| GF-3 | 600.0 | 130.8 | 18.7 | 180.0 | 20.0 | 6.5 | 10.7 |
| GF-4 | 600.0 | 123.9 | 59.6 | 172.9 | 3.5 | 0 | 0 |

Preparation Of Feed

### Feed FSC-1

Frit GFC-1, prepared above, was partially crushed using a disc mill (available under the trade designation “PULVERIZING DISC MILL” from Bico, Inc., Burbank, Calif.) equipped with ceramic discs and having a 0.030-inch (0.762-mm) outer gap. The resultant milled frit (approx 700 g increments) was then further milled in a fluid bed jet mill (available under the trade designation “ALPINE MODEL 100 APG” from Hosokawa Micron Powder Systems, Summit, N.J.), yielding Feed FSC-1, median size=22.58 micrometers, span=1.13.

### Feeds FSC-3, FSC-4, FSC-6, FSC-7, and FSC-9

The procedure for making feedstock FSC-1 was followed except using frits GFC-3, GFC-4, GFC-6, GFC-7, and GFC-9 in place of GFC-1 resulting in feedstocks FSC-3, FSC-4, FSC-6, FSC-7, and FSC-9, respectively, with median size and span values as reported in Table 2.

### Feeds FSC-2, FSC-5, FSC-8 and FS-1 through FS-4

The procedure of feed FSC-1 was followed using to generate feeds FSC-2, FSC-5, FSC-8 and FS-1 through FS-4 from frits GFC-2, GFC-5, GFC-8 and GF-1 through GF-4, respectively, except that after milling, each milled frit was classified into two portions using a centrifugal air classifier (available under the trade designation “ALPINE CLASSIFIER MODEL 100 MZR” from Hosokawa Micron Powder Systems). Typically, a coarse fraction and a fine fraction were isolated. Feeds FS-1 through FS-6 correspond to the coarse fraction and Feedstocks FSC-2, FSC-5, and FSC-8 correspond to the fine fraction. After classification, FS-4 was screened through a 230 mesh (U.S. mesh size) sieve.

Preparation Of Glass Microbubbles

### Glass Microbubbles RPC-1

Feed FSC-1, prepared above, was passed through a natural gas/air flame of approximately stoichiometric proportions with a combustion air flow calculated to be about 25.7 liters/minute at standard temperature and pressure and an output rate of approximately 2.75 pounds/hr (1.25 kg/hr). The air:gas ratio was adjusted to yield the lowest total product density. The flame-formed product was cooled by mixing with ambient temperature air and then separated from the resulting gas stream with a cyclone device. The resulting glass microbubbles (glass microbubbles RPC-1) had a median size of 74.8 with a span of 1.72.

### Glass Microbubbles RPC-2 through RPC-9 and RP-1 through RP-4

Glass microbubbles RPC-2 to RPC-9 and RP-1 through RP-4 were prepared according to the procedure used for preparing glass microbubbles RPC-1 (above) except using Feedstocks FSC-2 through FSC-9 and FS-1 through FS-4, respectively, instead of Feed FSC-1, and using the values of gas flow and output rate reported in Table 2 (below). Further, in preparing RP-4, the flame temperature was increased by enrichment with oxygen.

TABLE 2

| | | | | | | | | Raw Product | | |
|---|---|---|---|---|---|---|---|---|---|---|
| | Feed Particle | | | | | | | Particle Size | | |
| | Size Distribution | | | | | Raw Product | Raw Product | Distribution | | |
| | Median size, | | Raw | Gas flow, | Output rate, | Density | Standard | Median size, | | Strength, |
| Feed | micrometers | Span | Product | liters/min | lbs/hr; (kg/hr) | (g/mL) | Deviation | micrometers | Span | psi (MPa) |
| FSC-1 | 22.58 | 1.72 | RPC-1 | 25.7 | 2.75 | 0.125 | 26.10 | 74.79 | 0.93 | 190 |
| | | | | | (1.25) | | | | | (1.31) |
| FSC-2 | 12.35 | 1.96 | RPC-2 | 25.7 | 2.68 | 0.157 | 17.54 | 51.61 | 0.91 | 233 |
| | | | | | (1.21) | | | | | (1.61) |
| FSC-3 | 35.43 | 1.81 | RPC-3 | 25.7 | 2.60 | 0.161 | 35.2 | 95.30 | 1.01 | 124 |
| | | | | | (1.18) | | | | | (0.86) |
| FSC-4 | 25.51 | 1.66 | RPC-4 | 27.6 | 2.80 | 0.501 | 16.85 | 42.86 | 1.09 | 11,500 |
| | | | | | (1.27) | | | | | (79.3) |
| FSC-5 | 14.92 | 1.85 | RPC-5 | 27.6 | 2.80 | 0.557 | 12.21 | 28.17 | 1.12 | 16,638 |
| | | | | | (1.27) | | | | | (114.7) |
| FSC-6 | 38.18 | 1.75 | RPC-6 | 27.6 | 2.72 | 0.594 | 23.77 | 57.05 | 1.15 | 9,653 |
| | | | | | (1.23) | | | | | (66.6) |
| FSC-7 | 10.06 | 1.45 | RPC-7 | 25.7 | 2.70 | 0.205 | 14.70 | 33.85 | 1.07 | 300 |
| | | | | | (1.22) | | | | | (2.07) |
| FSC-8 | 7.19 | 1.52 | RPC-8 | 25.7 | 2.70 | 0.245 | 15.93 | 24.20 | 1.56 | 339 |
| | | | | | (1.22) | | | | | (2.34) |
| FSC-9 | 10.64 | 1.43 | RPC-9 | 27.6 | 2.70 | 0.620 | 10.90 | 17.84 | 1.20 | 22,377 |
| | | | | | (1.22) | | | | | (154.28) |
| FS-1 | 36.75 | 0.87 | RP-1 | 25.7 | 2.77 | 0.099 | 21.20 | 88.18 | 0.62 | 170 |
| | | | | | (1.26) | | | | | (1.17) |
| FS-2 | 38.46 | 0.86 | RP-2 | 27.6 | 2.80 | 0.412 | 12.21 | 54.30 | 0.58 | 9300 |
| | | | | | (1.27) | | | | | (64.12) |
| FS-3 | 14.85 | 0.77 | RP-3 | 25.7 | 2.75 | 0.158 | 9.00 | 34.93 | 0.60 | 300 |
| | | | | | (1.25) | | | | | (2.07) |
| FS-4 | 74.61 | 0.72 | RP-4 | 27.6 | 1.0 | 0.399 | 23.09 | 109.2 | 0.56 | 4436 |
| | | | | | (0.45) | | | | | (30.59) |

TABLE 3

| | | | | | | |
|---|---|---|---|---|---|---|
| | Cost/lb | Density | Weight | Weight | Volume | Volume |
| Component | $ | g/cc | lbs | % | Gal | % |

Packaged emulsion explosive proposed formulation
with Dead-pressing resistance
Comparative Example C-1

| | | | | | |
|---|---|---|---|---|---|
| Base emulsion | 1.38 | 94.00 | 94.00 | 8.16 | 80.77 |
| *K-37 Glass | 0.37 | 6.00 | 6.00 | 1.94 | 19.23 |
| Bubbles | | | | | |
| Totals | 1.19 | 100.00 | 100.00 | 10.10 | 100.00 |

Proposed formulation using specific strength raw product
resulting in higher volume fraction explosive
concentration at the same sensitized density
Example 1

| | | | | | |
|---|---|---|---|---|---|
| Base emulsion | 1.38 | 97.22 | 97.22 | 8.44 | 83.54 |
| 0.20 g/cc, | 0.200 | 2.78 | 2.78 | 1.66 | 16.46 |
| 3000 PSI | | | | | |
| Totals | 1.19 | 100.00 | 100.00 | 10.10 | 100.00 |

*K-37 Glass Bubbles available from 3M Company, St. Paul, MN.

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of forming a syntactic foam composite comprising a) heating feed under conditions sufficient to convert at least a portion of the feed into raw product comprising glass microbubbles, wherein the feed has a size distribution with a span of less than 0.9, and b) incorporating said raw product in a polymeric resin.

2. The method of claim 1 wherein said feed is provided by a method comprising milling frit to provide milled frit and classifying said milled frit.

3. The method of claim 2 wherein classifying comprises air classifying.

4. The method of claim 1 wherein said span is less than 0.85.

5. The method of claim 1 wherein said span is less than 0.80.

6. The method of claim 1 wherein said span is less than 0.75.

7. The method of claim 1 wherein said span is in a range of from at least 0.7 up to, but not including, 0.9.

8. The method of claim 1 wherein said feed has a silica content in a range of from 65 to 75 percent by weight.

9. The method of claim 1 wherein said feed has sulfur content in a range of from 0.01 to 0.65 percent by weight.

10. The method of claim 1 wherein said raw product has a median particle size in a range of from 3 to 250 micrometers.

11. The method of claim 1 wherein said raw product has a median particle size in a range of from 5 to 110 micrometers.

12. The method of claim 1 further comprising isolating glass microbubbles from the raw product and incorporating said isolated glass microbubbles into said polymeric resin.

13. The method of claim 1 wherein said raw product has a median particle size of at least 70 micrometers.

14. The method of claim 1 wherein said polymeric resin is selected from the group consisting of polyurethanes, polyolefins, epoxies, silicones, and blends thereof.

15. A syntactic foam comprising raw product dispersed in a polymeric resin, wherein on a weight basis a majority of the raw product comprises glass microbubbles, and wherein the plurality of raw product has a size distribution with a span of less than 0.80.

16. The foam of claim 15 wherein the span is less than 0.75.

17. The foam of claim 15 wherein the span is less than 0.70.

18. The foam of claim 15 wherein the span is less than 0.65.

19. The foam of claim 15 wherein the span is less than 0.60.

20. The foam of claim 15 wherein the glass microbubbles have a weight ratio of alkaline earth metal oxide to alkali metal oxide weight ratio in a range of 1.2:1 to 3.0:1, and wherein at least 90 percent by weight of the combined oxides comprises 70 to 80 percent SiO₂, from 8 to 15 percent CaO, from 3 to 8 percent Na₂O, and from 2 to 10 percent B₂O₃.

21. The foam of claim 15 wherein the raw product has a distribution with a median particle size in a range of from 3 to 250 micrometers.

22. The foam of claim 15 wherein the raw product has a distribution with a median particle size in a range of from 5 to 150 micrometers.

23. A method of providing a water-based explosive comprising the steps of:
a) heating feed under conditions sufficient to convert at least a portion of the feed into raw product comprising glass microbubbles, wherein the feed has a size distribution with a span of less than 0.9, b) incorporating an effective amount of said raw product into a liquid explosive composition.

24. A water-based explosive comprising (a) aqueous oxidizer solution (b) fuel and (c) raw product, wherein said raw product has a size distribution with a median particle diameter in the range of 3 to 150 micrometers, and on a weight basis a majority of the raw product has a size distribution with a span of less than 0.80.

25. The explosive of claim 24 wherein the span is less than 0.75.

26. The explosive of claim 24 wherein the span is less than 0.70.

27. The explosive of claim 24 wherein the span is less than 0.65.

28. The explosive of claim 24 wherein the span is less than 0.60.

29. The explosive of claim 24 wherein the raw product comprises glass microbubbles wherein said glass microbubbles have a weight ratio of alkaline earth metal oxide to alkali metal oxide weight ratio in a range of 1.2:1 to 3.0:1, and wherein at least 90 percent by weight of the combined oxides comprises 70 to 80 percent SiO₂, from 8 to 15 percent CaO, from 3 to 8 percent Na₂O, and from 2 to 10 percent B₂O₃.

30. The explosive of claim 24 wherein the raw product has a size distribution with a 5 median particle diameter in a range of from 5 to 100 micrometers .

31. The explosive of claim 24 wherein the raw product has a size distribution with a median particle diameter in a range of from 10 to 80 micrometers.

32. The explosive of claim 24 wherein the oxidizer is selected from the group consisting of nitrate, chlorate, or perchlorate salts of ammonium, sodium or potassium; hydrazines; organic amides; and combinations thereof.

33. The explosive of claim 24 wherein the fuel is selected from the group consisting of fuel oil, diesel fuel, gasoline, kerosene, jet fuel, alcohols, waxes, solid organic particles, metal particles, and combinations thereof.

34. The explosive of claim 24 wherein the raw product is present in an amount of at least 0.1 dry weight percent.
